(19) United States
(12) Patent Application Publication
(10) Pub. No.: US 2017/0154022 A1
(43) Pub. Date: Jun. 1, 2017

(54) INFORMATION PROCESSING APPARATUS, METHOD FOR CONTROLLING THE SAME, AND STORAGE MEDIUM

(71) Applicant: CANON KABUSHIKI KAISHA, Tokyo (JP)

(72) Inventor: Zhicheng Wang, Tokyo (JP)

(21) Appl. No.: 15/357,773

(22) Filed: Nov. 21, 2016

(30) Foreign Application Priority Data
Nov. 26, 2015 (JP) 2015-230275

(51) Int. Cl. G06F 17/24; G06F 3/0484; G06Q 10/10; G06F 3/0482

(52) U.S. Cl. CPC G06F 17/243; G06F 3/0482; G06F 3/0484; G06Q 10/10

(57) ABSTRACT

According to one embodiment, an information processing apparatus is provided which enables, when a business form document to be edited on a web browser is generated, arrangement of a layer-conscious graphic by outputting layer type information about each of the business form pages in the business form document, to improve work efficiency.

### BACKGROUND

Field of the Invention

The present invention relates to processing (overlay output) for overlaying a form (form information file) generated by a form generation apparatus and data (field data) in a text format to generate document data, and a method for editing and displaying generated business form data.

Description of the Related Art

In recent years, the number of companies which replace paper media information with electronic data for the purpose of enhancing operational efficiency and saving resources by going paperless, has been increasing. For example, a work business form, which is used in as operation within a company, may be subject to replacement with an electronic form. In particular, operational costs for a business form output by a core system can become enormous because a large number of pages are output. Therefore, such business forms have been computerized in a positive manner.

Furthermore, methods for utilizing the business form are widely diversifying to take advantage of the computerization. For example, in one method, a customer can be requested to confirm each of the items in business form document data (for example, relating to a contract) displayed on a web browser using a tablet terminal, and can be requested to create a confirmation signature on the tablet terminal. To implement such a process, a web application for web browsing and operating the business form document data on the web browser becomes necessary.

Merely computerizing an existing paper business form, which is being used in the company's operations, is not enough to establish a foundation for performing interactive operations such as a check of items and an electronic signature, even if data of the business form is displayed on a web browser. In such situations, a method for adding and arranging, for the computerized business form, a check box function for each of the items on the business form, or a function for inputting a handwritten. signature in an appropriate location within the business form data, becomes necessary. Further, it is desirable to add and arrange each of the functions on the web browser in light of the fact that the business form is in the end browsed and operated on the web browser. Japanese Patent Application Laid-Open No. 2006-65827 discusses a technique for scanning a paper business form to generate a business form image, displaying the business form image on a web page, and placing an object such as a character or a graphic on the business form image, to edit the business form image.

An existing business form generation application includes a feature for overlaying field data on form information representing a template portion of a business form, such as a frame, to generate a business form image, and printing the generated form image. The business form generation application includes a feature capable of designating a layer in the form information when generating the form information, and arranging a business form graphic having a specific function. The layer includes an element representing a hierarchical relationship in the same page (a top layer, a background layer, etc.) and an element representing an anteroposterior relationship among different images (a page type indicating a page where the layer is arranged, e.g., a front saver layer in which the layer is arranged on the first page, a back cover layer in which the layer is arranged on the last page, etc.).

It may be desired that a signed object is arranged on the last page of the business form document when the business form document is edited on the web browser. However, when the object was arranged on the business form image displayed on the web page using the web browser, as discussed in Japanese Patent Application Laid-Open No. 2006-65827, previously there has been no concept of using anything like a layer in the context at using form information. When form information and field data are overlaid to dynamically generate a business form document, the number of pages in the generated business form document can differ depending on the amount of the overlaid field data. Therefore, every time field data is overlaid on form information to generate a business form document, a user is required to designate the last page of the newly generated business form document, and arrange the signed object an the designated last page. Thus, the work efficiency of editing business forms on a web browser can be low in the case of a system involving dynamically generating the business form.

### SUMMARY

According to various embodiments of the present disclosure, an information processing apparatus includes a first output unit configured to output pages in a business form document which is generated by overlaying form information about the business form document with sample field data, and to output information about layer types, a first generation unit configured to generate an editing screen of the business form document, based on the output information about layer types and the output pages in a business form document, and an arrangement unit configured to arrange a business form graphic according to one of the layer types designated by a user on the editing screen of the business form document.

Further features will become apparent from the following description of exemplary embodiments with reference to the attached drawings.

### BRIEF DESCRIPTION OF THE DRAWINGS

FIG. 1 illustrates an example of a system configuration according to a first exemplary embodiment.

FIG. 2 illustrates an example of a hardware configuration of a business form generation server and a client device in the first exemplary embodiment.

FIG. 3 illustrates an example of a configuration of software modules which operate on the business form generation server in the first exemplary embodiment.

FIG. 4 illustrates a configuration of a form information file in the first exemplary embodiment.

FIG. 5 illustrates an example of overlay output processing is the first exemplary embodiment.

FIG. 6 illustrates a sequence of processing for generating a business form editing screen in the first exemplary embodiment.

FIG. 7 illustrates the flow of the overlay output processing in the first exemplary embodiment.

FIG. 8 illustrates a data structure stored in a page type information database in the first exemplary embodiment.

FIG. 9 illustrates the business form editing screen is the first exemplary embodiment.

FIG. 10 illustrates a data structure stored in a business form graphic information database in the first exemplary embodiment.

FIG. 11 illustrates a sequence of processing for generating a business form browsing screen in the first exemplary embodiment.

FIG. 12 illustrates the business form browsing screen in the first exemplary embodiment.

FIG. 13 illustrates a sequence of processing for generating a sample field data file in a second exemplary embodiment.

FIG. 14 illustrates a sequence of processing for adding a business form graphic to a business form page on a business form editing screen in the second exemplary embodiment.

FIG. 15 illustrates a layer type selection dialog in the business form editing screen in the second exemplary embodiment.

### DESCRIPTION OF THE EMBODIMENTS

Exemplary embodiments will be described below with reference to the drawings.

First, general overlay output processing will be described. In the overlay output, form information for recording information about a frame in a document sheet format and recording data in a text format (field data) are overlaid and output. A form registration function in a business form generation server used, to previously register the information about the frame etc. in the document sheet format as the form information. When the form information, together with the field data, is output using the business form generation server, the form information and the field data can be overlaid and output by using a function referred to as form information calling (or page information calling). Such overlay and output is defined as overlay output. An overlay output result can be printed on a sheet by a printer or output as an electronic file using a virtual printer.

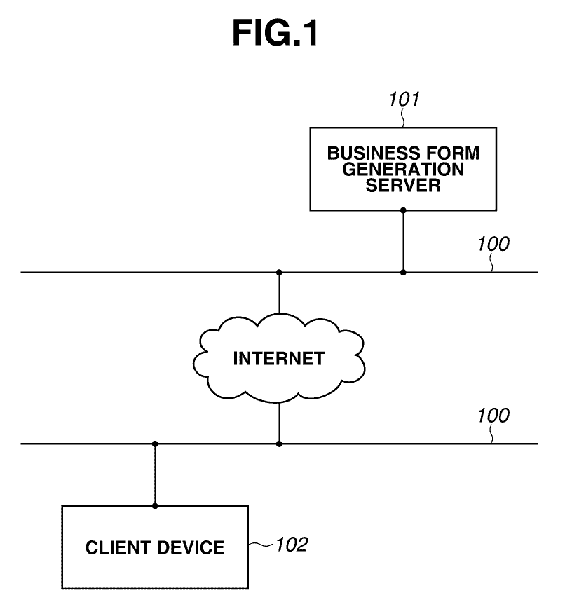

FIG. 1 illustrates an example of a system configuration according to a first exemplary embodiment of the present disclosure stem illustrated in FIG. 1 includes a business form generation server 101 and a client device 102. The business form generation server 101 is an information processing apparatus according to the present exemplary embodiment, and performs overlay output processing as well as processing for electronic business form editing and generating browsing programs. More specifically, the business form generation server 101 overlays a field data file serving as text data and a form information file including predetermined form information to generate a print page and instructs a virtual printer generate the generated print page as an electronic file. A business form file in a format of the generated electronic file is used to generate a program for editing or browsing business form file.

Business form editing and browsing programs in the present exemplary embodiment are web applications operating on a web browser which can be transmitted via a network. In many cases, the web applications are applications which operate with a mash up language (a HyperText Markup Language (HTML)) representing a web page and a programming language (JavaScript (registered trademark)) operating on the web browser. The business form editing and browsing programs are applications which are displayed on the web browser, hence are respectively referred to as a business form editing screen and a business form browsing screen. The business form editing and browsing programs may be applications other than the web applications operating on the web browser, e.g., applications operating on a computer system. Alternatively, the business form generation server 101 may be configured to make only an application for generating an electronic business form file and a file representing calculation-related matters between fields described below, and the client device 102 may be provided with an application for recreating the business form editing or browsing described below, using the above files.

The business form generation server 101 receives a request from the client device 102, to perform the overlay output processing and the business form editing and browsing program generation processing, described above.

Components described above are communicably connected to one another via a network 100. The network 100 may be any of a local area network (LAN) such as the Internet, a wide area network (WAN), a telephone line, dedicated digital line, an Asynchronous Transfer Mode (ATM) or frame relay line, a cable television line, and a data broadcasting wireless line, for example. Alternatively, the network may be a so-called communication network implemented by a combination of the above lines as long as data can be transmitted and received.

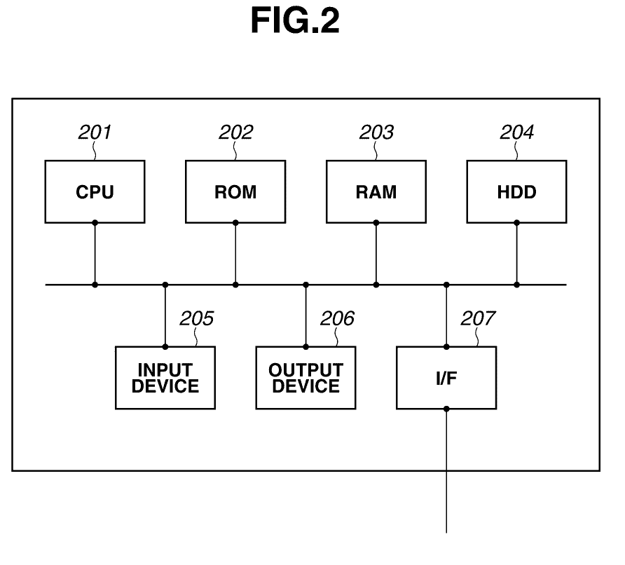

FIG. 2 is a block diagram illustrating hardware configuration of the business form generation server 101 and the client device 102 illustrated in FIG. 1.

A central processing unit (CPU) 201 directly or indirectly controls each of devices (a read only memory (ROM), a random access memory (RAM), etc., described below) which are connected to one another via an internal bus, to execute a program for implementing the present invention. A ROM 202 stores a Basic Input/Output System (BIOS). A RAM (direct storage device) 203 is used as a work area of the CPU 201 or used as temporary storage for loading software module for implementing the present invention.

An indirect storage device 204 is a hard disk drive (HDD) or a solid state drive (SSD) storing an operating system (OS) serving as basic software and software modules. An input device 205 is a keyboard or a pointing device (not illustrated). A display is connected to an output device 206. An interface (I/F) 207 is used for connecting to the network 100.

In these pieces of hardware, the CPU 201 executes the BIOS after the apparatus is started up, and the OS is loaded into the RAM 203 from the HDD 204 for execution. The CPU 201 loads various types of software modules described below for execution, into the RAM 203 from the HDD 204 according to an operation of the OS. The various types of software modules are executed by the CPU 201 for operation while the above described devices are cooperating with one another. The I/F 207 is connected to the network 100, and is controlled by the CPU 201 according to the operation of the OS, to implement communication by the communication means described above.

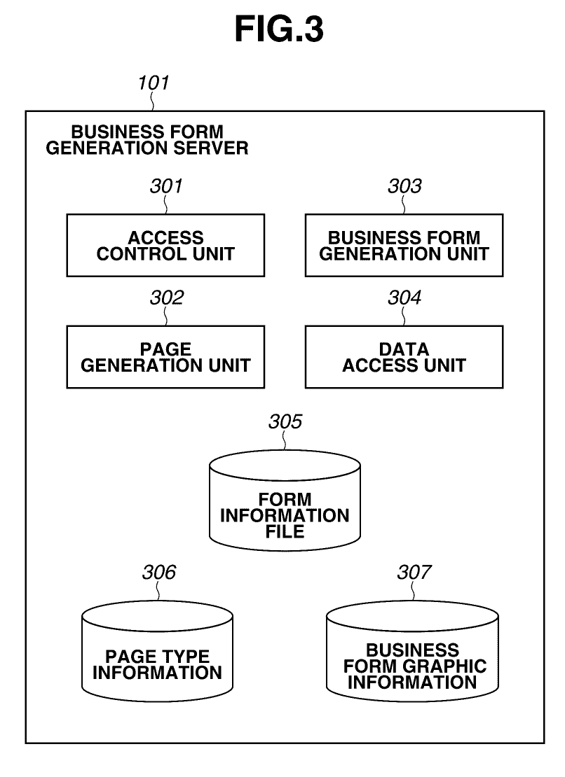

FIG. 3 illustrates an example of a configuration of software modules which operate on the business form generation server 101. Each of the software modules is stored in the HDD 204 illustrated in FIG. 2, and is loaded into the RAM 203 and executed by the CPU 201, as described above.

An access control unit 301 receives a request from the client device 102.

A page generation unit 302 generates and displays a business form editing screen on the web browser to return. a response to the client device 102. The page generation unit 302 also generates a file in a language such as an HTML or JavaScript required for the above described web applications serving as the business form editing and browsing programs, which is returned to the client device 102.

A business form generation unit 303 overlays form information represented by a form information file 401 and field data represented by a field data file 501, to generate print data Further, the business form generation unit 303 generates a business form page serving as an electronic file using software such as a virtual printer from the generated print data.

A data access unit 304 performs processing for accessing each of databases 305, 306, and 307. The database 305 is a database storing the form information file 401. The database 306 is a database storing page type information generated during business form overlay processing. The database 307 is a database storing business form graphic information added on the business form editing screen.

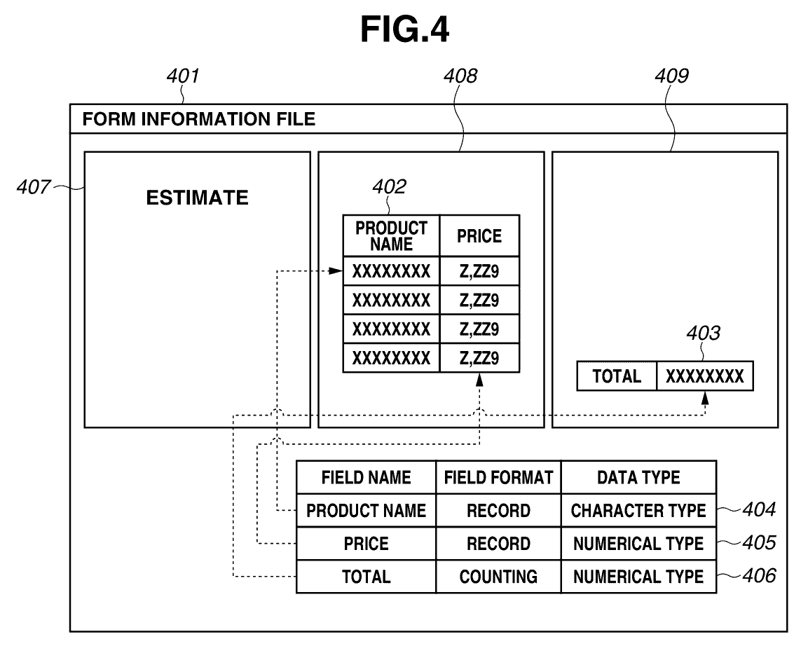

FIG. 4 illustrates a configuration of the form information file 401. The form information file 401 can be generated using a dedicated form information design system. The form information generally includes a fixed graphic not dependent on field data (a fixed graphic such as a character and a graphic not dependent on field data) and a graphic to be displayed according to an output format in which the received field data is designated (field graphic). To generate the field graphic, items (fields) for receiving the field data need to be previously generated. The field can be generated from a dedicated screen displayed in the form information design system. When the field graphic is generated, the field graphic is internally associated with the field serving as a generation source.

For a field graphic in a table format (a table graphic) 402, field data needs to be received in units of records. Therefore, record fields 404 and 405 need to be generated. A field format for generating the field data by counting fields using a designated counting method is defined as a counting field. In a case of a field graphic 403, a counting field 406 needs to be generated to indicate a counting method which is designated for field.

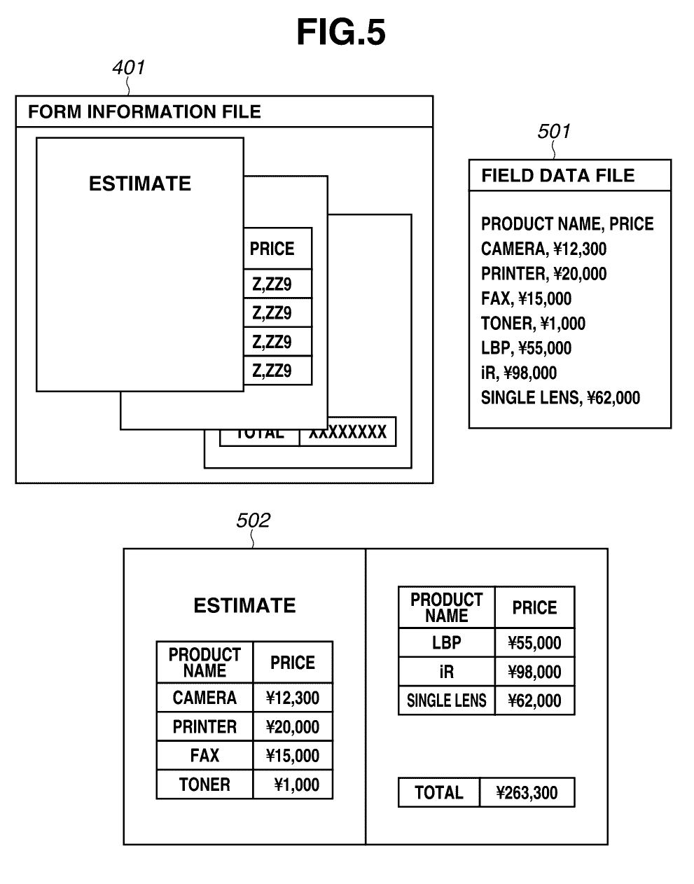

For the table graphic 402, an upper limit of the subsequent page can be set. When the table graphic 402 and field data corresponding thereto are overlaid to perform overlay output processing, the upper limit of the subsequent page set for the table graphic 402 means a starting position in a case where drawing is continued on the subsequent page, if the table graphic 402 does not fall within one page in a data repetition direction of the graphic. In the present exemplary embodiment, the upper limit of the subsequent page set for the table graphic 402 is set at a position located above an arranged position of the table graphic 402. The setting indicates that a starting position of the table graphic 402 on the second page is located above a starting position of the table graphic 402 on the first page as a result of overlay processing illustrated in FIG. 5.

A cover sheet layer 407 is a layer drawn on the first page of a business form document. A detail layer 408 is a layer drawn subsequently to the cover sheet layer 407. A back cover layer 409 is a layer drawn on the last page of the business form document (subsequently to the detail layer 408). Each of the layers 407, 408, and 409 represents a “layer” which is a characteristic of various embodiments of the present disclosure. In the form information file 401, it is possible to set whether the cover sheet layer 407 and the detail layer 408, and the back cover layer 409 and the detail layer 408 are respectively drawn on the same pages.

FIG. 5 illustrates an example of the overlay output processing performed by the business form generation server 101.

The business form generation unit 303 in the business form generation server 101 reads a form information file 401 which defines a field graphic, and a field data file 501. The business form generation unit 303 overlays the form information file 401 and the field data file 501, which have been read, to execute overlay output. An overlay output result 502 is illustrated in FIG. 5. In this example, the cover sheet layer 407 and the detail layer 408 are drawn on the same page, and the detail layer 408 and the back cover layer 409 are drawn on the same page.

A specific operation of the present exemplary embodiment will be described below.

### [Processing for Generating Business Form Editing Screen]

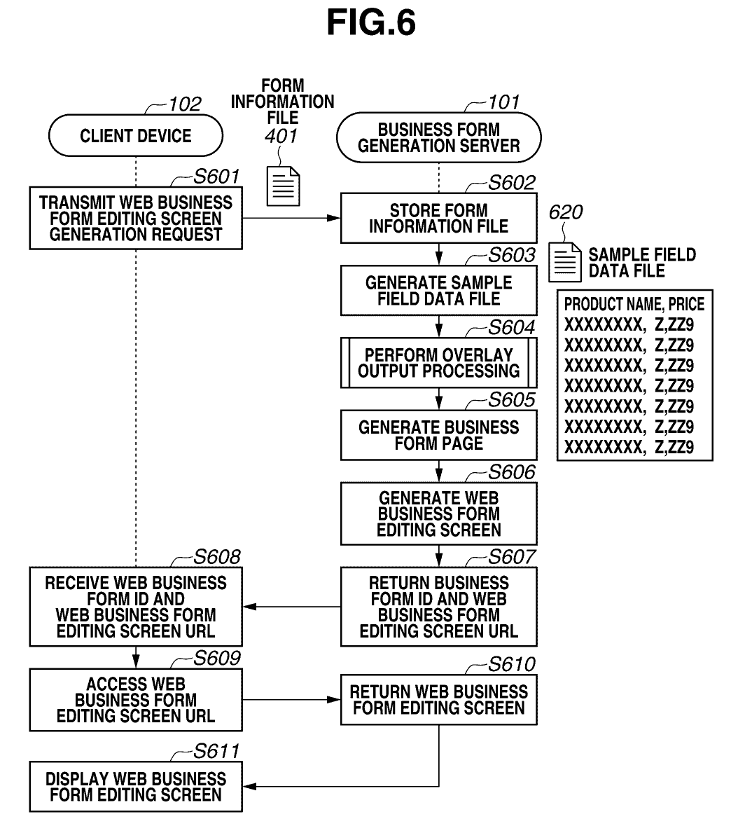

FIG. 6 illustrates a sequence of processing for generating the business form editing screen (program) to be displayed on the web browser in the exemplary embodiment.

In step S601, a user transmits a request for generating business form editing screen to the business form generation server 101 using the web browser in the client device 102. The form information file 401 serving as an overlay output processing target needs to be attached in the request for generating business form editing screen.

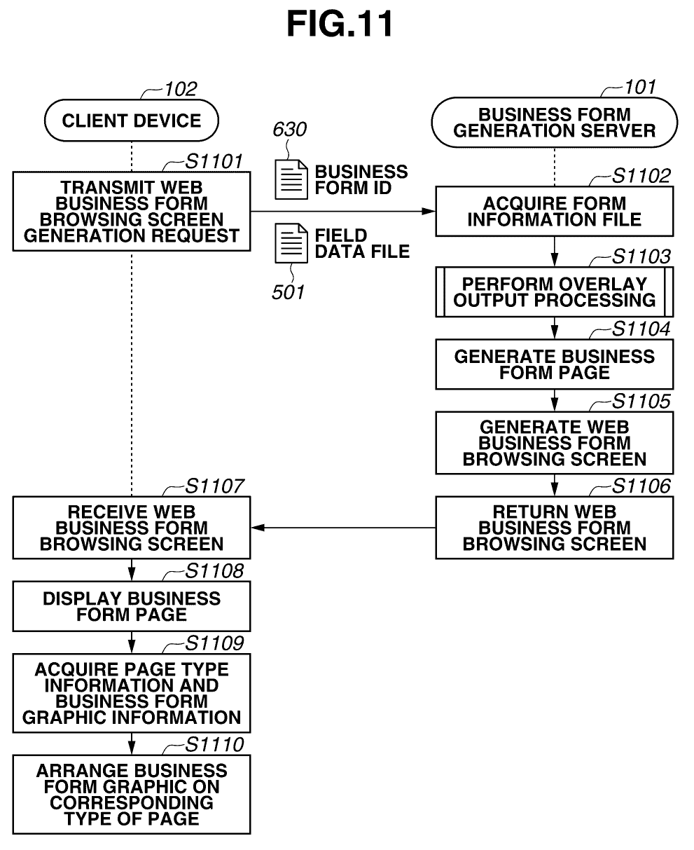

In step S602, the access control unit 301 in the business form generation server 101 stores the form information file 401, which has been acquired via the data access unit 304, in the form information file database 305, and generates business form identification (ID) 630 (see FIG. 11) for identifying the stored form information file 401.

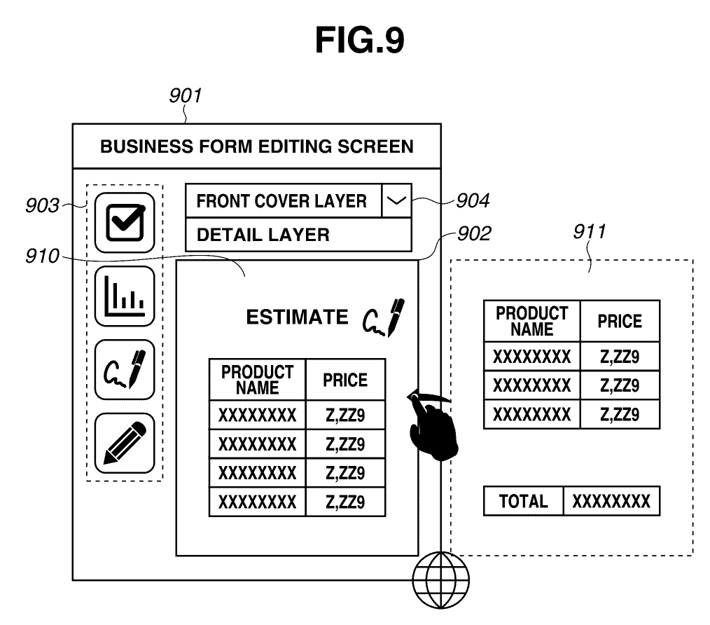

In step S603, the business form generation unit 303 in the business form generation server 101 generates sample field data file 620 for generating a business form page to be displayed on the business form editing screen. The sample field data file 620 is general-purpose field data not representing any specific data pattern, which is generated to represent a general-purpose layout image of a business form document made with the use of the form information file 401 and the field data file 501. The sample field data file 620 is a sample field data file used in the present exemplary embodiment. Business form documents 910 and 911 illustrated in FIG. 9 are generated using the sample field data file 620 and the form information file 401.

In step S604, the business form generation unit 303 in the business form generation server 101 performs overlay output processing using the form information file 401, which has been acquired via the access control unit 301, and the sample field data file 620 which has been generated in step S603.

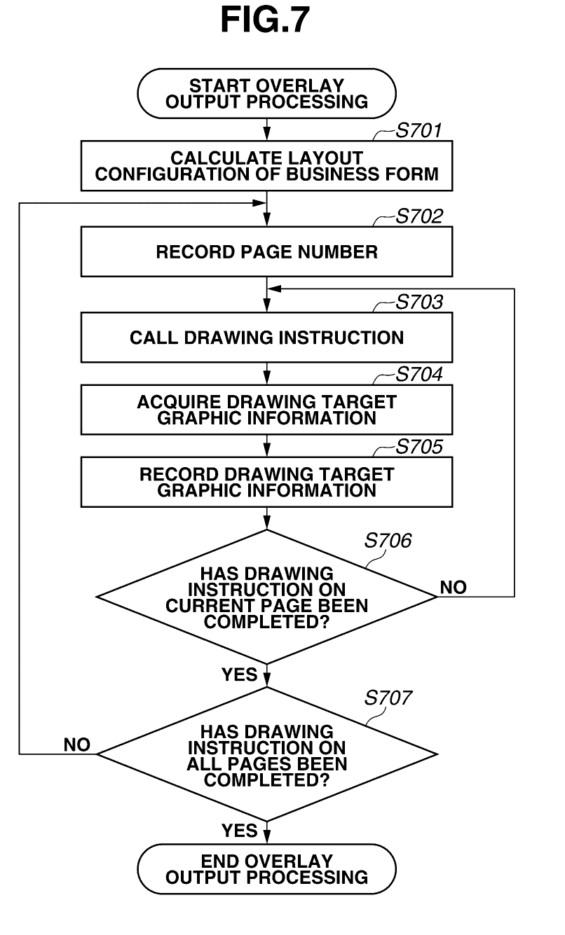

The overlay output processing in step S604 will be specifically described below with reference to FIG. 7.

### [Overlay Output Processing]

FIG. 7 is a flowchart illustrating the overlay output processing performed by designating the form information file 401 and the sample field data file 620 in the business form generation server 101 according to the exemplary embodiment.

In step S701, a layout configuration of an output business form is calculated using the form information file 401 included in the business form screen generation request in step S601 and the sample field data file 620 which has been generated in step S603. In step S701 and the subsequent steps, graphics are drawn in order of page according to the layout configuration obtained in step S701.

In step S702, a number of a page on which the graphic is currently drawn is recorded on the page type information database 306 via the data access unit 304.

In step S703, instructions to draw each graphic are sequentially called and executed according to the layout configuration which has been obtained in step S701.

In step S704, the business form generation unit 303 acquires information about the graphic targeted by the drawing instruction which has been executed in step S703, from the form information file 401. The acquired information includes at least information about a layer type of the page to which the graphic belongs. To realize a layer type automatic determination unit described below according to a second exemplary embodiment, information. representing upper, left, and right drawing positions of the graphic to be drawn also needs to be acquired.

In step S705, the information about the current graphic to be drawn, which has been acquired in step SS704, is recorded on the page type information database 306 via the data access unit 304.

In step S706, the business form generation unit 303 determines whether the drawing instruction on the current page has been completed based on the layout configuration which has been obtained in step S701. If the business form generation unit 303 determines that the drawing instruction on the current page has not been completed (NO in step S706), the processing returns to step S703. In step S703, the subsequent drawing instruction is executed. If the business form generation unit 303 determines that the drawing instruction on the current page has been completed (YES in step S706), the processing proceeds to step S707.

In step S707, the business form generation unit 303 determines whether the respective drawing instructions on all the pages have been completed. If the business form generation unit 303 determines that the drawing instructions on all the pages have not been completed (NO in step S707), the processing returns to step S702. In step S702, the drawing instruction on the subsequent page is started. If the business form generation unit 303 determines that the drawing instructions on all the pages have been completed (YES in step S707), the overlay output processing ends.

In the foregoing, the overlay output processing has been described with reference to FIG. 7, and the processing returns to the description illustrated in FIG. 6.

In step S605, the business form generation unit 303 generates a business form page in a Portable Document Format (PDF) via a virtual printer using Page Description Language (PDL) information (a page description language for issuing a drawing instruction to a printer) obtained as a result of the overlay output processing an step S604. Further, the generated business form page in the PDF format is converted into a business form page in a Scalable Vector Graphics (SVG) format. The business form page in the PDF format is converted into an editable format (the SVG format in the present exemplary embodiment) because a business form page file cannot be directly edited on the web browser.

In step S606, the page generation unit 302 in the business form generation server 101 generates a business form editing screen to be displayed on the web browser. The generated business form editing screen includes the business form page in the SVG format generated in step S605, and a JavaScript program for controlling browsing, editing, and an operation of the business form page file. Further, the business form editing screen includes page type information stored in the page type information database 306 in the overlay output processing in step S604.

In step S607, the business form generation server 101 returns the business form ID 630 generated in step S602, and a Uniform Resource Locater (URL) for accessing the business form editing screen generated in step S606, to the client device 102.

In step S608, the client device 102 receives a response from the business form generation server 101.

In step S609, the client device 102 accesses from the web browser the URL of the business form editing screen, which has been received in step S608.

In step S610, the business form generation server 101 returns the business form editing screen generated in step S606, to the client device 102.

In step S611, the client device 102 receives the response from the business form generation server 101, and displays the business form editing screen on the web browser. The displayed business form editing screen is illustrated in FIG. 9.

In the foregoing, the sequence of the processing for generating the business form editing screen has been described with reference to FIG. 6.

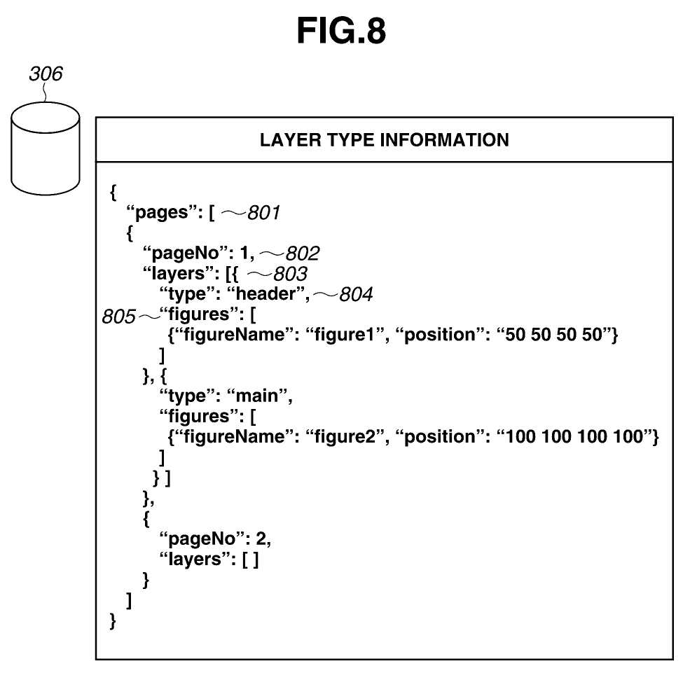

FIG. 8 illustrates a data structure stored in the page type information database 306 in the exemplary embodiment. While the data in the page type information database 306 is represented by a Key-Value structure in FIG. 8, the data may be represented by a structure other than the Key-Value structure.

A page information key (“pages”) 801 is a key storing information about each of pages. A page number key (“pageNo”) 802 is a key storing a page number. A layer information key (“layer”) 803 is a key storing layer information about the page corresponding to the page number stored in the page number key 802. Layer information about each of layer types is stored in the layer information key 803. A type key (“type”) 804 is a key storing type information about a layer. A graphic key (“figures”) 805 is a key storing information about each of graphics in a drawn business form.

### [Business Form Editing Screen]

FIG. 9 illustrates a business form editing screen 901 in the exemplary embodiment. Business form pages 910 and 911 are generated in the SVG format using the sample field data file 620 and the form information file 401 in step S603.

The business form pages 910 and 911 in the SVG format are displayed in a business form display area 902. When a flick operation in a transverse direction performed in the business form display area 902, the business form page can be switched to previous and subsequent business form pages.

In an editing tool 903, icons for arranging graphic objects (referred to as business form graphics) such as a check box, a graph, a signature, and a handwritten curve are displayed. All layer types included in the business form page displayed in the business form page display area 902 axe displayed in a layer type selection combo box 904. The user can select the layer type from the layer type selection comb box 904.

When the user performs an operation for dragging and dropping the editing tool into the business form page display area 902, a business form graphic corresponding to the editing tool is added to a layer which is being selected in the layer type selection comb box 904, in the business form editing screen 901.

Processing performed when the user performs the operation for dragging and dropping the editing tool into the business form page display area 902 will be specifically described below. In this case, a JavaScript program that operates in the business form editing screen 901, transmits the type of the editing tool which has been dragged and dropped, the layer type which is displayed in the layer type selection combo box 904, and positional information about a place where a drop operation has been performed, to the business form generation server 101. The business form generation server 101 stores the transmitted information in the business form graphic information database 307 via the data access unit 304.

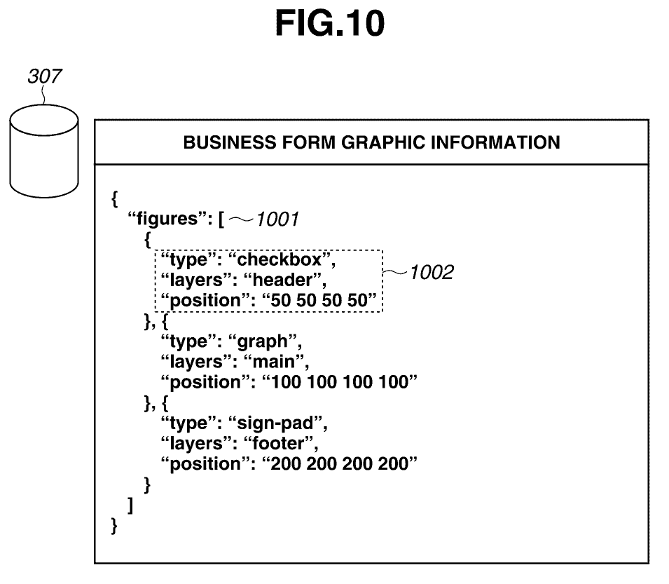

FIG. 10 illustrates a structure of data stored in the business form graphic information database 307 in the exemplary embodiment. A business form graphic key (“figures”) 1001 is a key storing each of business form graphics. Data 1002 representing one business form graphic includes a type of a business form graphic, a layer type to which the business form graphic belongs and information about a position where the business form graphic is displayed.

Thus, according to a first exemplary embodiment, when the business form graphic (object) is arranged by designating the layer type on the business form page displayed on the web browser, the object can be added to the designated layer type in the form information.

### [Browsing Sequence]

FIG. 11 illustrates a sequence of processing for generating a business form browsing screen 1201 to be displayed on the web browser in the exemplary embodiment.

In step S1101, the user transmits a request for generating business form browsing screen to the business form generation server 101 via the web browser in the client device 102. A business form ID 630 of a form information file which is an overlay output processing target and a field data file 501 need to be added to the request for generating the business browsing screen.

In step S1102, the access control unit 301 in the business form generation server 101 acquires the form information file corresponding to the business form ID 630 from the form information file database 305 via the data access unit 304.

In step S1103, the business form generation unit 303 in the business form generation server 101 uses the form information file acquired in step S1102, and the field data file 501 attached to the business form browsing screen generation request in step S1101, to perform overlay output processing. The overlay output processing in step S1103 has the same sequence as the processing illustrated in FIG. 7, in which page type information is stored in the page type information database 306.

In step S1104, a business form page is generated in the SVG format using a result of the overlay output processing in step S1103, like in step S605.

In step S1105, the page generation unit 302 in the business form generation server 101 generates the business form browsing screen 1201 to be displayed on the web browser. The generated business form browsing screen 1201 includes the business form page in the SVG format generated in step S1104, and a JavaScript program for controlling an operation of browsing a business page file. Further, the business form browsing screen 1201 includes the page type information stored in the page type information database 306 in the overlay output processing in step S1103, and the business form graphic information stored in the business form graphic information database 307.

In step S1106, the business form generation server 101 returns the business form browsing screen 1201, which has been generated in step S1105, to the client device 102.

In step S1107, the client device 102 receives a response from the business form generation server 101.

In step S1108, the client device 102 displays the business form page on the web browser based on the information which has been received in step S1107.

In step S1109, the client device 102 acquires the page type information and the business form graphic information which has been received in step S1107.

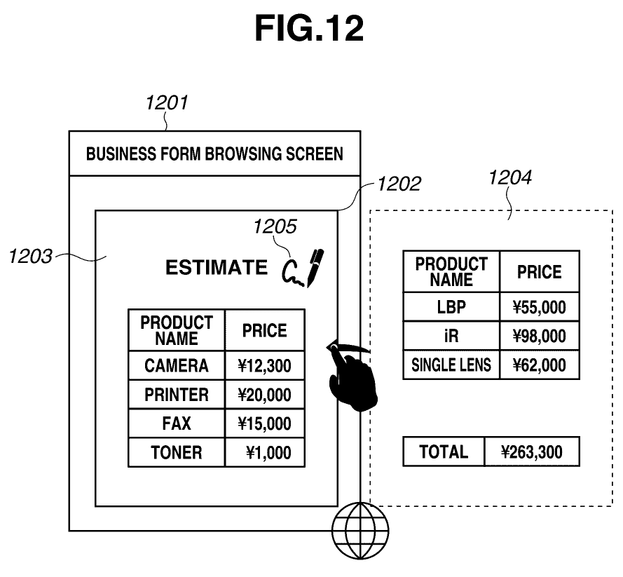

In step S1110, the client device 102 arranges each of the business form graphics on the corresponding type of page based on the information which have been acquired in step S1109. At this stage, processing for displaying the business form browsing screen 1201 ends. The displayed business form browsing screen 1201 is illustrated in FIG. 12.

In the foregoing, the sequence of the processing for generating the business form browsing screen 1201 has been described with reference to FIG. 11.

FIG. 12 illustrates the business form browsing screen 1201 in the exemplary embodiment.

Business form pages 1203 and 1204 are each the page in the SVG format which has been generated in step S1104. Graphics are drawn in both a front cover layer and a detail layer on the business form page 1203, and graphics are drawn in the detail layer and a back cover layer on the business form page 1204. The business form pages 1203 and 1204 in the SVG format are displayed in a business form page display region 1202. When a flick operation in transverse direction is performed in the business form display area 1202, the business form page can be switched to previous or subsequent business form pages. A signature graphic 1205 has been added on the business form editing screen 901 by the user. The front cover layer is drawn only on the business form page 1203. Therefore, it can be seen that the signature graphic 1205 is added to only the business form page 1203.

In the above described first exemplary embodiment, the user needs to previously select a layer at an add destination in the layer type selection comb box 904 before adding the business form graphic to the business form page using the drag and drop operation on the business form editing screen 901. In a second exemplary embodiment, which is described below, a user can automatically determine a layer without selecting the layer at the add destination.

### [Processing for Generating Sample Field Data File]

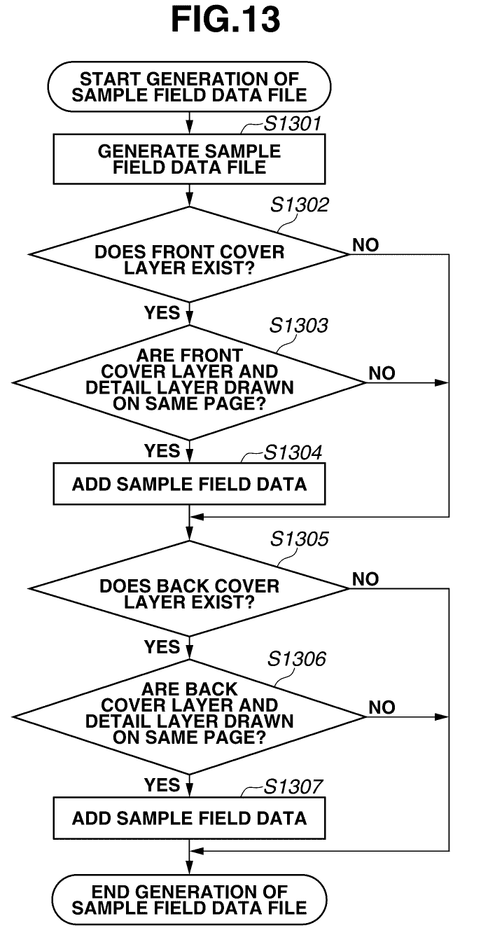

FIG. 13 is a flowchart illustrating the flow of processing for generating a sample field data file in step S603 (see FIG. 6) in the second exemplary embodiment.

To automatically determine a layer at the add destination of a business form graphic, described above, it is desirable to place dispersedly layers of different layer types among different business form pages. If the number of data items in a table graphic to be displayed in a detail layer is small, for example, all a front cover layer, the detail layer, and a back cover layer may be drawn on the same business form page. When the respective layers of the layer types are aggregated on the same business form page, an area range of each layer is narrowed, and the accuracy of automatic determination of the layer at the add destination of the business form graphic decreases. Further, operability also decreases when the user performs an operation for dragging and dropping the business form graphic on a business form editing screen. To solve such problems, the sample field data file used when generating the business form page to be displayed on the business form editing screen has to be generated so that the respective layers of the layer types are not aggregated on the same business form page.

In step S1301, the page generation unit 302 in the business form generation server 101 generates a sample field data file, similar to step S603.

In step S1302, the page generation unit 302 in the business form generation server 101 determines whether the front cover layer exists in a form information file. If it is determined that the front cover layer does not exist in the form information file (NO in step S1302), the processing proceeds to step S1305. If it is determined that the front cover layer exists in the form information file (YES in step S1302), the processing proceeds to step S1303.

In step S1303, the page generation unit 302 in the business form generation server 101 determines whether a setting for drawing the front cover layer and the detail layer on the same page in the form information file is valid. If it is determined that the setting for drawing the front cover layer and the detail layer on the same page is not valid (No in step S1303), the processing proceeds to step S1305. If it is determined that the setting for drawing the front cover layer and the detail layer on the same page is valid (YES in step S1303), the processing proceeds to step S1304.

In step S1304, the page generation unit 302 in the business form generation server 101 newly adds sample field data to the sample field data file, which has been generated in step S1301 so that the detail layer has two pages. The number of items in the sample field data to be added is calculated by settings (the number of lines and arrangement coordinates) of a table graphic 402 arranged in the detail layer and the number of items in the current sample field data.

In step S1305, the page generation unit 302 in the business form generation server 101 determines whether the back cover layer exists in the form information file. If the page generation unit 302 in the business form generation server 101 determines that the back cover layer does not exist in the form information file (NO in step S1305), the processing ends. If the page generation unit 302 in the business form generation server 101 determines that the back cover layer exists in the form information. file (YES in step S1305), the processing proceeds to step S1306.

In step S1306, the page generation unit 302 in the business form generation server 101 determines whether a setting for drawing the back cover layer and the detail layer on the same page in the form information file is valid. If it is determined that the setting for drawing the back cover layer and the detail layer on the same page is not valid (NO in step S1306), the processing ends. If it is determined that the setting for drawing the back cover layer and the detail layer on the same page is valid (YES in step S1306), the processing proceeds to step S1307.

In step S1307, the page generation unit 302 in the business form generation server 101 adds sample field data based on information about the form information file.

On the business form editing screen in the second exemplary embodiment, the layer type need not be selected. Thus, a layer type selection comb box 904 does not exist. The other screen display is the same as that on the business form editing screen 901 in the first exemplary embodiment, and hence illustration thereof is not repeated. The following description will be made using the business form editing screen 901 in the first exemplary embodiment.

### [Processing (2) for Adding Business Form Graphic to Business Form Page]

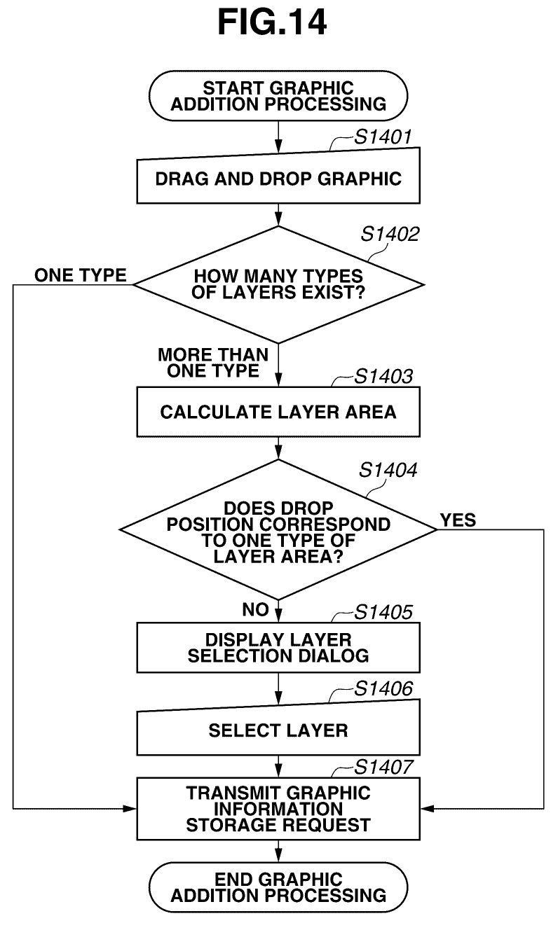

FIG. 14 is a flowchart illustrating the flow of processing for adding a business form graphic to a business form page on the business form editing screen in the second exemplary embodiment.

In step S1401, an operation for dragging and dropping a business form graphic within a business form graphic tool 903 into a business form page display area 902 on a business form editing screen 901 to be displayed in a client device 102.

In step S1402, a JavaScript program in the business form editing screen 901 determines a number of layer types which exist on a business form page as a drop operation target in step S1401. If it is determined that only one type of business form page exists as a drop operation target in step S1401, the processing proceeds to step S1407. If it is determined that more than one type of business form page serving exist as a drop operation target in step S1401, the processing proceeds to step S1403.

In step S1403, the JavaScript program in the business form editing screen 901 calculates a layer area of each layer type included in the business form page serving as a drop operation target. When the layer area of each layer type is calculated, a square area which can cover all business form graphics, is calculated based on positional information about each of the business form graphics stored within a graphic key 805 in a layer type information key.

In step S1404, the JavaScript program in the business form editing screen 901 determines a relationship between coordinates of a drop position of the business form graphic and each of the layer areas which has been calculated in step S1403, and determines whether coordinates of the drop position of the business form graphic correspond to only one type of layer area. If it is determined that the coordinates of the drop position of the business form graphic correspond to only one type of layer area (YES in step S1404), the processing proceeds to step S1407. If it is determined that the coordinates of the drop position of the business form graphic correspond to more than one type or no type of layer area (NO in step S1404), processing proceeds step S1405.

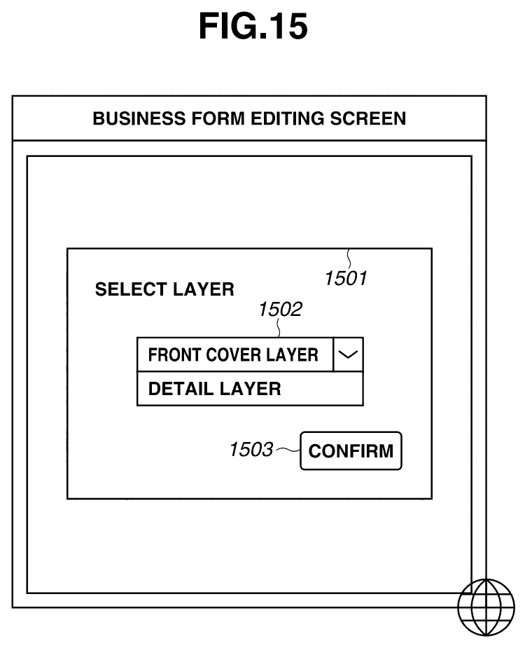

In step S1405, the JavaScript program the business form editing screen 901 displays a layer selection diagram 1501 illustrated in FIG. 15.

In step S1406, the user selects a layer where a business form graphic to be dragged and dropped is desired to be arranged from a layer type selection comb box 1502 in the layer selection dialog 1501 displayed in the business form editing screen 901. When a confirmation button 1503 in the layer selection dialog 1501 is pressed, the selection is finalized.

In step S1407, the client device 102 transmits the following data to the business form generation server 101 via the JavaScript program in the business form editing screen 901:
the type of the business form graphic which has been dragged and dropped,
the layer if only one type of layer exists on the business form page in step S1402 or if the drop position corresponds to one type of layer area in step S1404, and the type of the selected layer a layer has been selected in step S1406, and
positional information about a place where a drop operation is performed.

As described above, in the second exemplary embodiment, in the processing for adding the business form graphics, a method for automatically determining the layer type from an area where the business form graphic has been dragged and dropped is implemented, and the user is supposed to select the layer type only when the layer type cannot be determined.

As described above, according to various embodiments, in a system for dynamically generating a business form, a business form graphic can be flexibly added and set in each of layers, and work for editing the business form can be efficiently performed.

### Other Embodiments

Embodiments of the present disclosure can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk as a compact disc (CD), digital versatile disc (DVD), or Blu-ray Disc (BD)™), a flash memory device, a memory card, and the like.

While exemplary embodiments have been described, it is to be understood that the invention is not limited to the disclosed exemplary embodiments. The scope of the following claims is be accorded the broadest interpretation so as to encompass all such modifications and equivalent structures and functions.

This application claims the benefit of Japanese Patent Application No. 2015-230275, filed Nov. 26, 2015, which is hereby incorporated by reference herein in its entirety.

What is claimed is:

1. An information processing apparatus comprising:
a first output unit configured to output pages in a business form document which is generated by overlaying form information about the business form document with sample field data, and to output information about layer types;
a first generation unit configured to generate an editing screen of the business form document, based on the information about layer types and the pages in a business form document which are output by the first output unit; and
an arrangement unit configured to arrange a business form graphic according to one of the layer types designated by a user on the generated editing screen of the business form document.

2. The information processing apparatus according to claim 1, wherein
a second generation unit configured to generate a browsing screen of the business form document generated by overlaying the form information about the business form document with field data, and
a display unit configured to display a business form graphic belonging to each of the layer types on the browsing screen of the business form document.

3. The information processing apparatus according to claim 1, wherein the arrangement unit includes a determination unit configured to determine the layer type of the layer area where the business form graphic is arranged, from coordinates on which the business form graphic is arranged.

4. The information processing apparatus according to claim 3, wherein the arrangement unit displays a layer type selection dialog on the editing screen when the determination unit cannot specify the layer area.

5. The information processing apparatus according to claim 1, wherein the first generation unit includes a unit configured to generate the sample field data so that the layer areas of the different layer types are not aggregated on the same page in the generated business form document.

6. A method for controlling an information processing apparatus, the method comprising:
outputting pages in a business form document which is generated by overlaying form information about the business form document with sample field data, and outputting information about layer types;
generating an editing screen of the business form document, based on the output information about layer types and the output pages in the business form document; and
arranging business form graphic according to of the layer types designated by user on the generated editing screen of the business form document.

7. A non-transitory computer-readable storage medium storing a computer program that causes a computer to:
output pages in a business form document which is generated by overlaying form information about the business form document with sample field data, and output information about layer types;
generate an editing screen of the business form document, based on the output information about layer types and the output pages in a business form document; and
arrange a business form graphic according to one of the layer types designated by a user on the generated. editing screen of the business form document.
